(19) United States
(12) Patent Application Publication
(10) Pub. No.: US 2025/0366504 A1
(43) Pub. Date: Dec. 4, 2025

(54) SEASONING STIRRING TABLE

(71) Applicant: Yindu Kitchen Equipment Co., Ltd., Hangzhou (CN)

(72) Inventor: Junjie ZHOU, Hangzhou (CN)

(73) Assignee: Yindu Kitchen Equipment Co., Ltd., Hangzhou (CN)

(21) Appl. No.: 18/798,876

(22) Filed: Aug. 9, 2024

(30) Foreign Application Priority Data
Jun. 4, 2024 (CN) 202421264735.0

(51) Int. Cl. A23P 20/15; A47J 43/046; A47J 43/07; A47J 43/08; A47J 47/01

(52) U.S. Cl. CPC A23P 20/15; A47J 43/046; A47J 43/0727; A47J 43/085; A47J 47/01

(57) ABSTRACT

The present disclosure provides a seasoning stirring table, and relates to the technical field of food production. The seasoning stirring table includes a machine frame and at least one first stirring device, wherein the first stirring device includes a feeding mechanism, a returning mechanism, a plurality of stirring assemblies, and a plurality of adding assemblies, wherein the plurality of stirring assemblies are sequentially arranged on the machine frame in a first direction, wherein the feeding mechanism is arranged on an upper end of the stirring assemblies, and the returning mechanism is arranged on a lower end of the stirring assemblies.

### CROSS-REFERENCE TO RELATED APPLICATION

The present disclosure claims priority to Chinese patent Application No. 2024212647350, filed with the Chinese Patent Office on Jun. 4, 2024, entitled “SEASONING STIRRING TABLE”, the entire contents of which are incorporated herein by reference.

### TECHNICAL FIELD

The present disclosure relates to the technical field of food production, especially to a seasoning stirring table.

### BACKGROUND ART

The fried food, such as chicken wings, and chicken legs, needs to be stirred with sauces according to the different taste of each person who chooses their favorite taste. The sauce stirring for the fried food in a chain restaurant at the present home and abroad is completed entirely by hand. The fried food is put into a stirring barrel manually; the desired sauce is manually pressed out from the sauce pump according to the amount of the fried food; and then the stirring barrel is shaken to stir well manually. The manual labor intensity is high and sometimes the stirring is uneven, and in addition, the manual operation is easy to cause configuration errors since the chain restaurant needs to prepare more than twenty sauces according to the tastes of different persons.

### SUMMARY

The purpose of the present disclosure is to provide a seasoning stirring table to solve the technical problems that the labor intensity of manual stirring is high, the stirring is uneven, and it is easy to stir wrong during the stirring process of food and sauce.

The present disclosure provides a seasoning stirring table, including a machine frame and at least one first stirring device, wherein the first stirring device includes a feeding mechanism, a returning mechanism (material returning mechanism), a plurality of stirring assemblies, and a plurality of adding assemblies, wherein
the plurality of stirring assemblies are sequentially arranged on the machine frame in a first direction, wherein the feeding mechanism is arranged on an upper end of the stirring assemblies, and the returning mechanism is arranged on a lower end of the stirring assemblies;
the machine frame is provided with the adding assemblies provided with the stirring assemblies in one-to-one correspondence, wherein the adding assemblies have an adding opening, and the adding opening faces the stirring assemblies; and
the first direction is a length direction of the machine frame.

In an optional embodiment, the feeding mechanism includes a first linear module and a feeding hopper, wherein the feeding hopper is arranged on the first linear module, and the first linear module pushes the feeding hopper to reciprocate in the first direction.

In an optional embodiment, a discharge opening is arranged on a lower end of the feeding hopper, and a flipping door panel is hinged at the discharge opening; and a flipping motor is arranged on the feeding hopper, and the flipping motor is connected to the flipping door panel.

In an optional embodiment, the returning mechanism includes a second linear module and a returning tray (material returning tray), wherein the returning tray is arranged on the second linear module, and the second linear module pushes the returning tray to reciprocate in the first direction.

In an optional embodiment, the returning mechanism further includes a food tray, wherein the food tray is arranged on the returning tray, and the second linear module pushes the food tray to move to a position corresponding to the stirring assembles.

In an optional embodiment, the stirring assemblies include a stirring barrel, a stirring motor, a mounting bracket, and a mounting plate, wherein a movable end of the stirring motor is arranged on the stirring barrel; the stirring motor is configured to rotate the stirring barrel;
the mounting plate is arranged on the stirring motor; the mounting bracket is connected to the machine frame; and the mounting bracket is provided with a rotation motor for rotating the mounting plate, wherein
a movable end of the rotation motor is connected to one end of the mounting plate; the other end of the mounting plate is hinged to the mounting bracket; and
the rotation motor is configured to flip the stirring barrel to pour food in the stirring barrel into the returning mechanism.

In an optional embodiment, the adding assemblies include a seasoning barrel, a seasoning pump, and an adding tube, wherein the seasoning pump is arranged in the seasoning barrel, and the adding tube is arranged on the seasoning pump; and
the adding tube is provided with the adding opening, wherein the seasoning pump is configured to add the seasoning in the seasoning barrel into the stirring assembles from the adding opening.

In an optional embodiment, the adding assemblies further include a pusher assembly (material pushing assembly), wherein the pusher assembly includes a third linear module and a push rod device; the third linear module is configured to push the push rod device to reciprocate in the first direction; and
the push rod device is provided with a press head; the push rod device makes the press head lift and fall; the third linear module pushes the press head to move above the seasoning pump; and the push rod device pushes the press head to press the seasoning pump.

In an optional embodiment, the seasoning stirring table includes a plurality of first stirring devices, and the plurality of first stirring devices are arranged in sequence from high to low.

In an optional embodiment, the seasoning stirring table includes two first stirring devices, and the two first stirring devices are arranged on two sides of the machine frame in the first direction.

The feeding mechanism of the seasoning stirring table provided by the present disclosure can add the food to be mixed with the sauce into the stirring assemblies; the adding assemblies add the corresponding sauce into the stirring assemblies; and the food is poured into the returning mechanism after the stirring assemblies completely stir the sauce with the food, so as to complete the stirring of the food and the sauce, wherein the stirring assemblies and the adding assemblies are arranged in one-to-one correspondence. The stirring assemblies fixed in this way can stir the food with fixed taste, so as to improve the accuracy of configuring the taste of the food.

### BRIEF DESCRIPTION OF DRAWINGS

In order to more clearly illustrate the technical solutions in the embodiments of the present disclosure or in the prior art, the drawings to be used in the description of the embodiments or prior art will be briefly introduced below. It is obvious that the drawings in the following description are some embodiments of the present disclosure. For a person of ordinary skill in the art, other drawings can be obtained based on these drawings without inventive efforts.

FIG. 1 shows a structure schematic diagram of a seasoning stirring table provided by the embodiments of the present disclosure;

FIG. 2 shows a structure schematic diagram of a feeding mechanism of a seasoning stirring table shown in FIG. 1;

FIG. 3 shows a structure schematic diagram of a feeding hopper of a feeding mechanism shown in FIG. 2;

FIG. 4 shows a structure schematic diagram of a feeding hopper of a feeding mechanism shown in FIG. 2 from another angle;

FIG. 5 shows a structure schematic diagram of a returning mechanism of a seasoning stirring table shown in FIG. 1;

FIG. 6 shows a structure schematic diagram of a seasoning pump of an adding assembly of a seasoning stirring table shown in FIG. 1;

FIG. 7 shows a structure schematic diagram of a pusher assembly of an adding assembly of a seasoning stirring table shown in FIG. 1;

FIG. 8 shows a structure schematic diagram of a stirring assembly of a seasoning stirring table shown in FIG. 1;

FIG. 9 shows a structure schematic diagram of a state of use of a stirring assembly of a seasoning stirring table shown in FIG. 8;

FIG. 10 shows a structure schematic diagram of another state of use of a stirring assembly of a seasoning stirring table shown in FIG. 8;

FIG. 11 shows a structure schematic diagram of another state of use of a stirring assembly of a seasoning stirring table shown in FIG. 8;

FIG. 12 shows a schematic diagram of another structure of a seasoning stirring table shown in FIG. 1; and

FIG. 13 shows a schematic diagram of another structure of a seasoning stirring table shown in FIG. 1.

### REFERENCE NUMBERS

100—machine frame; 200—feeding mechanism; 201—first linear module; 202—feeding hopper; 203—flipping motor; 204—flipping door panel; 205—discharge opening; 300—adding assembly; 301—seasoning barrel; 302—adding tube; 3021—adding opening; 303—seasoning pump; 304—third linear module; 305—push rod device; 3051—press head; 400—stirring assembly; 401—stirring barrel; 402—mounting plate; 403—stirring motor; 404—rotation motor; 405—mounting bracket; 500—returning mechanism; 501—second linear module; 502—returning tray; and 503—food tray.

### DETAILED DESCRIPTION OF EMBODIMENTS

The terms “first”, “second”, “third”, etc., are used only to distinguish descriptions, do not indicate ordering numbers, and cannot be understood as indicating or implying a relative importance.

Additionally, the terms “horizontal”, “vertical”, “overhanging”, etc., do not mean that the component must be absolutely horizontal or overhanging, but can be slightly inclined, e.g., “horizontal” only refers that it is more horizontal than “vertical”, and does not mean that the structure must be absolutely horizontal, but can be slightly inclined.

In the description of the present disclosure, it should be noted that orientations or positional relationships indicated by terms, such as “inside”, “outside”, “left”, “right”, “up”, and “down”, are the orientation or positional relationship based on the drawings, or the orientation or positional relationship that the product of the present disclosure is customarily placed in use, which are only to facilitate the description of the present disclosure and simplify the description, and are not to indicate or imply that the device or element referred to must have a particular orientation, or be constructed and operated with a particular orientation, and therefore cannot to be understood as limitations of the present disclosure.

In the description of the present disclosure, unless other express specifications and limitations, the terms “arrange”, “mount”, “connect”, and “link” are to be understood in a broad sense, e.g. in can be a fixed connection, a detachable connection, or an integral connection; it can be a mechanical connection or an electrical connection; and it can be a direct connection, an indirect connection through an intermediate medium, or a communication inside two elements.

The technical solutions of the present disclosure will be clearly and completely described below in conjunction with the drawings.

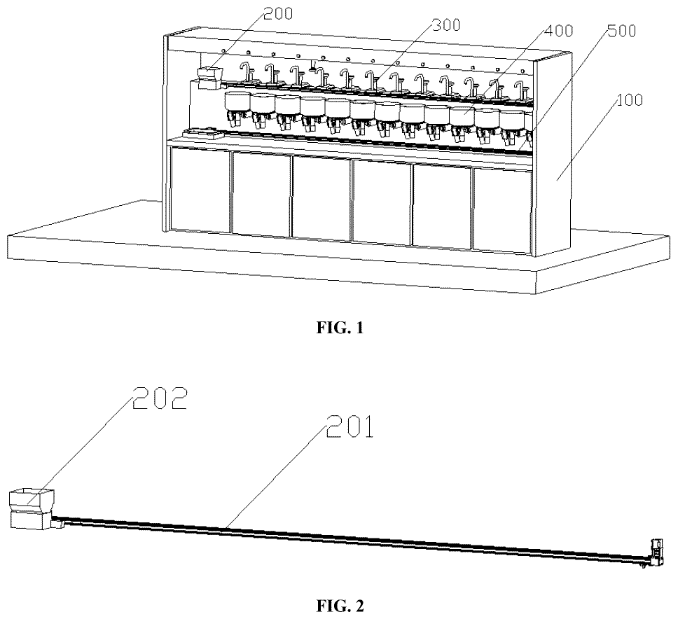

Referring to FIG. 1-FIG. 13, the present disclosure provides a seasoning stirring table, including a machine frame 100 and at least one first stirring device, wherein the first stirring device includes a feeding mechanism 200, a returning mechanism 500, a plurality of stirring assemblies 400, and a plurality of adding assemblies 300, wherein
the plurality of stirring assemblies 400 are sequentially arranged on the machine frame 100 in a first direction, wherein the feeding mechanism 200 is arranged on an upper end of the stirring assemblies 400, and the returning mechanism 500 is arranged on a lower end of the stirring assemblies 400;
the machine frame 100 is provided with the adding assemblies 300 provided with the stirring assemblies 400 in one-to-one correspondence, wherein the adding assemblies 300 have an adding opening 3021, and the adding opening 3021 faces the stirring assembles 400; and
the first direction is a length direction of the machine frame 100.

In some embodiments, the seasoning stirring table is configured to stir food with seasonings, wherein the seasonings are generally sauces. The plurality of stirring assemblies 400 are arranged on the machine frame 100, wherein each stirring assembly 400 is corresponding to an adding assembly 300; each adding assembly 300 is corresponding to a type of sauce; or the plurality of adding assemblies 300 are corresponding to a type of sauce.

According to the favor of the customer, the plurality of adding assemblies 300 can take the same sauce, i.e., it can be that each adding assembly 300 of the plurality of adding assembles 300 takes a type of sauce, or the plurality of adding assemblies 300 take the same sauce.

The feeding mechanism 200 places the food, generally fried food, into the designated stirring assembly 400; the adding assembly 300 adds the seasoning, generally the sauce, into the stirring assembly 400; the stirring assembly 400 completely stirs the food with the sauce; and then the stirring assembly 400 pours the stirred food into the returning mechanism 500, so as to complete the stirring of the food with the sauce.

The plurality of stirring assemblies 400 are sequentially arranged in the first direction, wherein each stirring assembly 400 is corresponding to an adding assembly 300; the adding assembly 300 is configured to spray the sauce into the stirring assembly 400; and the returning mechanism 500 is configured to convey back the food stirred by the stirring assemblies 400.

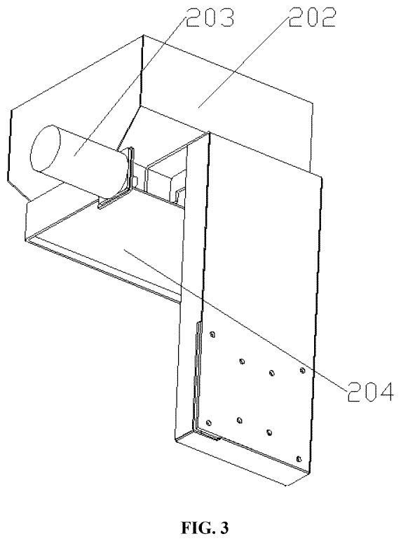

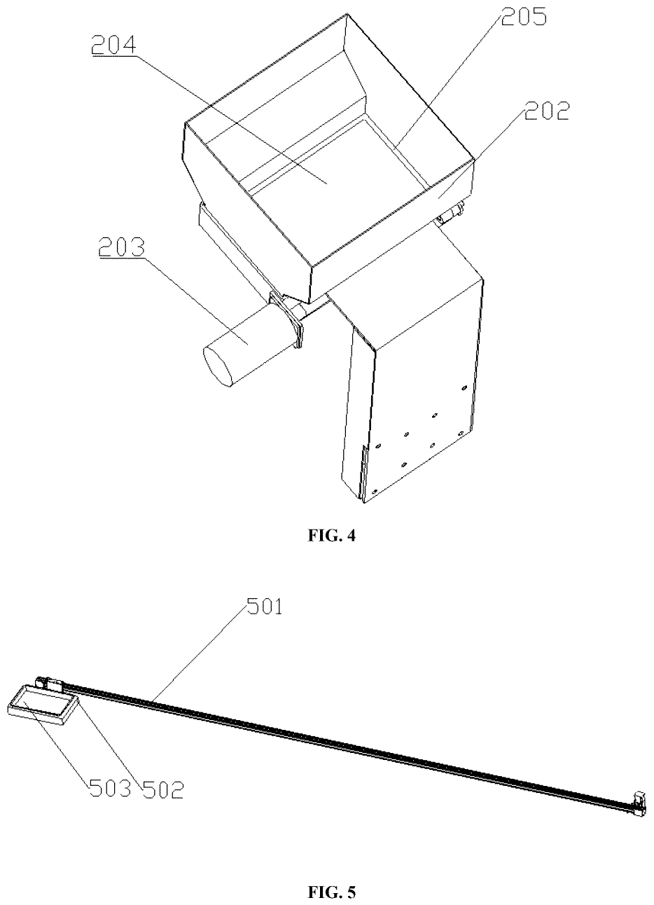

Referring to FIG. 2, FIG. 3 and FIG. 4, in an optional embodiment, the feeding mechanism 200 includes a first linear module 201 and a feeding hopper 202, wherein the feeding hopper 202 is arranged on the first linear module 201, and the first linear module 201 pushes the feeding hopper 202 to reciprocate in the first direction.

In some embodiments, the first linear module 201 of the feeding mechanism 200 is arranged in the first direction, and the first linear module 201 is the prior art. The first linear module 201 is provided with the feeding hopper 202, and the first linear module 201 pushes the feeding hopper 202 to move to the stirring assemblies 400 in different directions, i.e., the food in the feeding hopper 202 can be put into the different stirring assemblies 400.

In an optional embodiment, a discharge opening 205 is arranged on a lower end of the feeding hopper 202, and a flipping door panel 204 is hinged at the discharge opening 205; and a flipping motor 203 is arranged on the feeding hopper 202, and the flipping motor 203 is connected to the flipping door panel 204.

The discharge opening 205 is arranged on the lower end of the feeding hopper 202; the discharge opening 205 is hinged to the flipping door panel 204; and the flipping motor 203 is connected to the flipping door panel 204, wherein the flipping motor 203 rotates the flipping door panel 204, so that the flipping door panel 204 can open or close the discharge opening 205. When the feeding hopper 202 moves above the designated stirring assembly 400, the flipping motor 203 rotates the flipping door panel 204, so that the food in the feeding hopper 202 falls into the stirring assembly 400.

Referring to FIG. 5, in an optional embodiment, the returning mechanism 500 includes a second linear module 501 and a returning tray 502, wherein the returning tray 502 is arranged on the second linear module 501, and the second linear module 501 pushes the returning tray 502 to reciprocate in the first direction.

In an optional embodiment, the returning mechanism 500 further includes a food tray 503, wherein the food tray 503 is arranged on the returning tray 502, and the second linear module 501 pushes the food tray 503 to move to a position corresponding to the stirring assembles 400.

In some embodiments, the second linear module 501 of the returning mechanism 500 is arranged in the first direction. The returning tray 502 is arranged on the second linear module 501, and the second linear module 501 pushes the returning tray 502 to move to the position corresponding to the stirring assembly 400. The returning tray 502 is provided with a food tray 503, and the food in the stirring assembly 400 is poured into the food tray 503, wherein the food tray 503 is detachably connected to the returning tray 502. After the food is put into the food tray 503, the food tray 503 can be moved out of the returning tray 502.

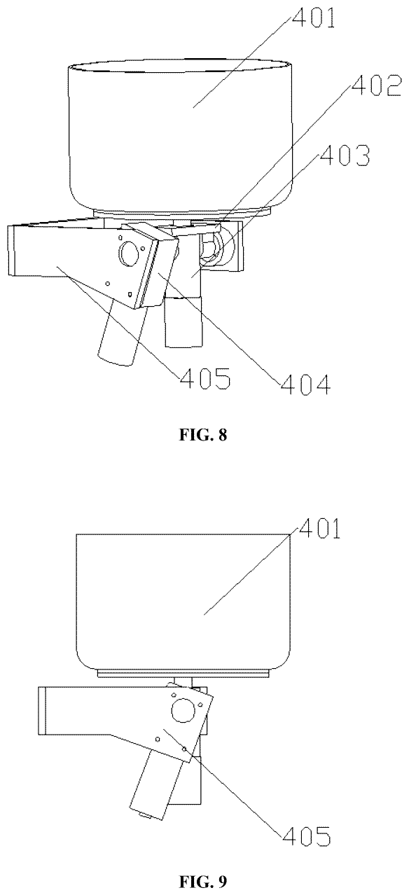

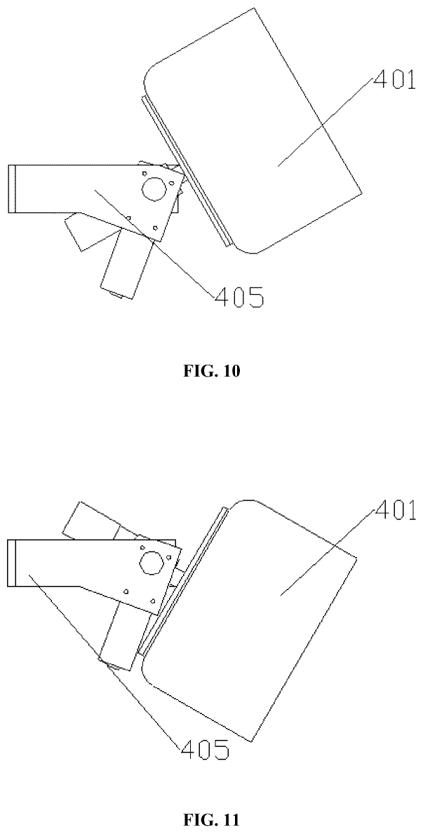

Referring to FIG. 8, FIG. 9, FIG. 10, and FIG. 11, in an optional embodiment, the stirring assemblies 400 include a stirring barrel 401, a stirring motor 403, a mounting bracket 405, and a mounting plate 402, wherein a movable end of the stirring motor 403 is arranged on the stirring barrel 401; and the stirring motor 403 is configured to rotate the stirring barrel 401;
the mounting plate 402 is arranged on the stirring motor 403; the mounting bracket 405 is connected to the machine frame 100; and the mounting bracket 405 is provided with a rotation motor 404 for rotating the mounting plate 402, wherein
a movable end of the rotation motor 404 is connected to one end of the mounting plate 402; the other end of the mounting plate 402 is hinged to the mounting bracket 405; and
the rotation motor 404 is configured to flip the stirring barrel 401 to pour food in the stirring barrel 401 into the returning mechanism 500.

In some embodiment, the movable end of the stirring motor 403 is connected to the stirring barrel 401, i.e., the stirring motor 403 can rotate the stirring barrel 401. When the stirring barrel 401 contains the food and sauce, the stirring motor 403 can completely mix the food with the sauce. The mounting bracket 405 is configured to connect to the machine frame 100; the mounting plate 402 is hinged to the plate mounting bracket 405; and the mounting bracket 405 is provided with the rotation motor 404, wherein the rotary motor 404 can rotate the mounting plate 402, so as to rotate the stirring barrel 401. Generally, the stirring barrel 401 can be in three states: the opening of the stirring barrel 401 faces up; the stirring barrel 401 has an angle of 80° with the vertical direction; and the stirring barrel 401 has an angle of 170° with the vertical direction. When the opening of the stirring barrel 401 faces up, the feeding mechanism 200 can put the food into the stirring barrel 401 from the discharge opening 205; and then the adding assembly 300 adds the sauce into the stirring barrel 401. The rotation motor 404 rotates the stirring barrel 401, so that the stirring barrel 401 has the angle of 80° with the vertical direction, at which time the stirring motor 403 rotates the stirring barrel 401, so that the sauce and the food are completely stirred. After the food and sauce are stirred well, the rotation motor 404 rotates the mounting plate 402 again. Generally, the opening of the stirring barrel 401 is at 170° from the vertical direction, and the food in the stirring barrel 401 is poured into the returning mechanism 500.

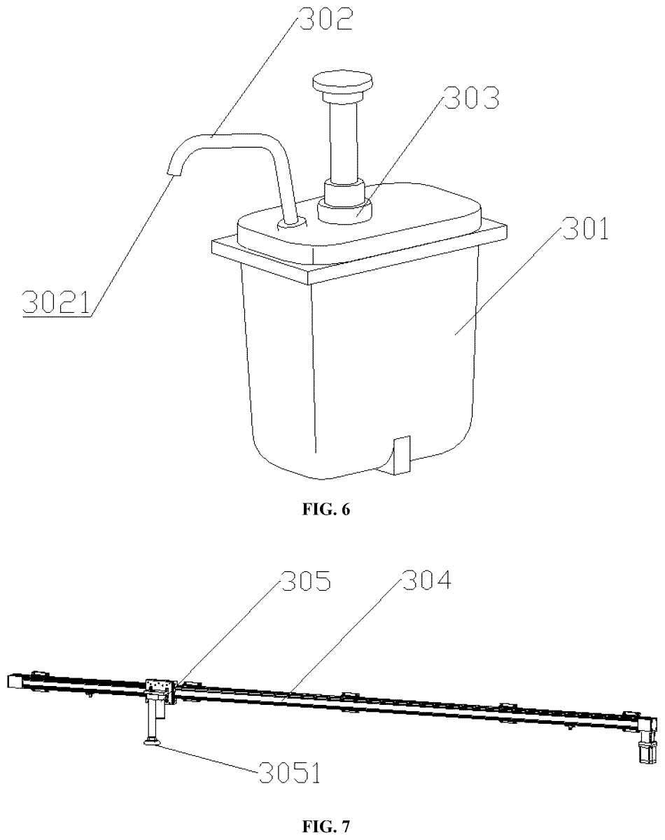

Referring to FIG. 6, in an optional embodiment, the adding assemblies 300 include a seasoning barrel 301, a seasoning pump 303, and an adding tube 302, wherein the seasoning pump 303 is arranged in the seasoning barrel 301, and the adding tube 302 is arranged on the seasoning pump 303; and
the adding tube 302 is provided with the adding opening 3021, wherein the seasoning pump 303 is configured to add the seasoning in the seasoning barrel 301 into the stirring assembles 400 from the adding opening 3021.

In some embodiments, the seasoning barrel 301 of the adding assembly 300 is configured to hold sauces, wherein there are many types of sauces, and one adding assembly 300 generally holds only one type of sauce. The seasoning pump 303 is arranged in the seasoning barrel 301, and the adding tube 302 is arranged on the seasoning pump 303, wherein the seasoning pump 303 can be directly controlled by using a control device. After food is added into the stirring assembly 400, the seasoning pump 303 adds the sauce into the stirring assembly 400 by the adding tube 302, so that the sauce can be added into the stirring assembly 400.

Referring to FIG. 7, in an optional embodiment, the adding assemblies 300 further include a pusher assembly, wherein the pusher assembly includes a third linear module 304 and a push rod device 305; the third linear module 304 is configured to push the push rod device 305 to reciprocate in the first direction; and
the push rod device 305 is provided with a press head 3051; the push rod device 305 makes the press head 3051 lift and fall; the third linear module 304 pushes the press head 3051 to move above the seasoning pump 303; and the push rod device 305 pushes the press head 3051 to press the seasoning pump 303.

In one embodiment, the seasoning pump 303 is a press-type seasoning pump 303; the plurality of adding assemblies 300 matches one pusher assembly; and the third linear module 304 pushes the push rod device 305 to move in the first direction. When the sauce is required to be added into the designated stirring assembly 400, the third linear module 304 pushes the push rod device 305 to move to the corresponding seasoning pump 303, and the press head 3051 of the push rod device 305 moves downwardly. The seasoning pump 303 is pressed, so that the seasoning pump 303 sprays the sauce into the stirring assembly 400.

The push rod device 305 is generally selected as a push rod, and the push rod is used to make the press head 3051 lift and fall.

Referring to FIG. 13, in an optional embodiment, the seasoning stirring table includes a plurality of first stirring devices, and the plurality of first stirring devices are arranged in sequence from high to low.

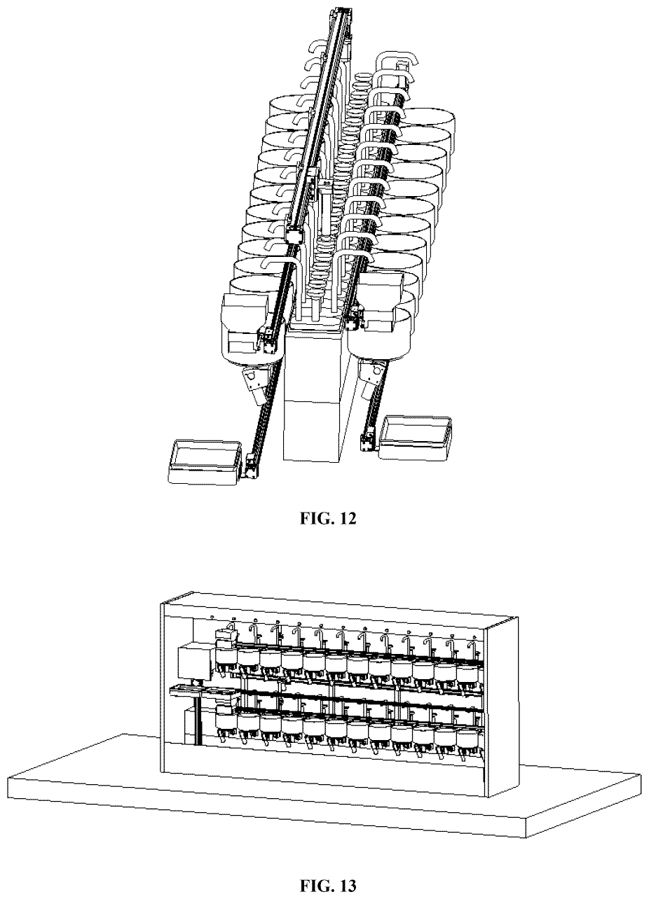

Referring to FIG. 12, in an optional embodiment, the seasoning stirring table includes two first stirring devices, and the two first stirring devices are arranged on two sides of the machine frame 100 in the first direction.

In some embodiments, the seasoning stirring table includes the plurality of first stirring devices, wherein the plurality of first stirring devices are arranged in sequence from high to low, and generally the seasoning stirring table is provided with two first stirring devices.

The two first stirring devices of the seasoning stirring table can further be arranged on two sides of the machine frame 100. The first stirring devices arranged in this way have the lower height, which is beneficial for the operator to operate.

The feeding mechanism 200 of the seasoning stirring table provided by the present disclosure can add the food to be mixed with the sauce into the stirring assembly 400; the adding assembly 300 adds the corresponding sauce into the stirring assembly 400; and the food is poured into the returning mechanism 500 after the stirring assembly 400 completely stirs the sauce with the food, so as to complete the stirring of the food and the sauce, wherein the stirring assembly 400 and the adding assembly 300 are arranged in one-to-one correspondence. The stirring assembly 400 fixed in this way can stir the food with fixed taste, so as to improve the accuracy of configuring the taste of the food.

Finally, it should be noted that the above embodiments are only used to illustrate the technical solutions of the present disclosure, and not to restrict it. Although the present disclosure is described in detail with reference to the foregoing embodiments, it should be understood by persons of ordinary skill in the art that they may still modify the technical solutions described in the foregoing embodiments or make equivalent substitutions for some or all of the technical features; and these modifications or substitutions do not make the essence of the corresponding technical solutions out of the scope of the technical solutions of the embodiments of the present disclosure.

What is claimed is:

1. A seasoning stirring table, comprising a machine frame and at least one first stirring device, wherein the first stirring device comprises a feeding mechanism, a returning mechanism, a plurality of stirring assemblies, and a plurality of adding assemblies, wherein
the plurality of stirring assemblies are sequentially arranged on the machine frame in a first direction, wherein the feeding mechanism is arranged on an upper end of the stirring assemblies, and the returning mechanism is arranged on a lower end of the stirring assemblies;
the machine frame is provided with the adding assemblies provided with the stirring assemblies in one-to-one correspondence, wherein the adding assemblies have an adding opening, and the adding opening faces the stirring assembles; and
the first direction is a length direction of the machine frame.

2. The seasoning stirring table according to claim 1, wherein the feeding mechanism comprises a first linear module and a feeding hopper, wherein the feeding hopper is arranged on the first linear module, and the first linear module pushes the feeding hopper to reciprocate in the first direction.

3. The seasoning stirring table according to claim 2, wherein a discharge opening is arranged on a lower end of the feeding hopper, and a flipping door panel is hinged at the discharge opening; and a flipping motor is arranged on the feeding hopper, and the flipping motor is connected to the flipping door panel.

4. The seasoning stirring table according to claim 1, wherein the returning mechanism comprises a second linear module and a returning tray, wherein the returning tray is arranged on the second linear module, and the second linear module pushes the returning tray to reciprocate in the first direction.

5. The seasoning stirring table according to claim 4, wherein the returning mechanism further comprises a food tray, wherein the food tray is arranged on the returning tray, and the second linear module pushes the food tray to move to a position corresponding to the stirring assemblies.

6. The seasoning stirring table according to claim 1, wherein the stirring assemblies comprise a stirring barrel, a stirring motor, a mounting bracket, and a mounting plate, wherein a movable end of the stirring motor is arranged on the stirring barrel; and the stirring motor is configured to rotate the stirring barrel;
the mounting plate is arranged on the stirring motor; the mounting bracket is connected to the machine frame; and the mounting bracket is provided with a rotation motor for rotating the mounting plate, wherein
a movable end of the rotation motor is connected to one end of the mounting plate; and the other end of the mounting plate is hinged to the mounting bracket; and
the rotation motor is configured to flip the stirring barrel to pour food in the stirring barrel into the returning mechanism.

7. The seasoning stirring table according to claim 1, wherein the adding assemblies comprise a seasoning barrel, a seasoning pump, and an adding tube, wherein the seasoning pump is arranged in the seasoning barrel, and the adding tube is arranged on the seasoning pump; and
the adding tube is provided with the adding opening, wherein the seasoning pump is configured to add a seasoning in the seasoning barrel into the stirring assemblies from the adding opening.

8. The seasoning stirring table according to claim 7, wherein the adding assemblies further comprise a pusher assembly, and the pusher assembly comprises a third linear module and a push rod device, wherein the third linear module is configured to push the push rod device to reciprocate in the first direction; and
the push rod device is provided with a press head; the push rod device makes the press head lift and fall; the third linear module pushes the press head to move above the seasoning pump; and the push rod device pushes the press head to press the seasoning pump.

9. The seasoning stirring table according to claim 1, wherein the seasoning stirring table comprises a plurality of first stirring devices, and the plurality of first stirring devices are arranged in sequence from high to low.

10. The seasoning stirring table according to claim 1, wherein the seasoning stirring table comprises two first stirring devices, and the two first stirring devices are arranged on two sides of the machine frame in the first direction.
